(19) United States
(12) Patent Application Publication
(10) Pub. No.: US 2025/0033284 A1
(43) Pub. Date: Jan. 30, 2025

(54) DEVICES, SYSTEMS, PROCESSES, AND METHODS RELATING TO 3D PRINTERS COMPRISING PRESSURIZED RESIN PRODUCTION OF THREE-DIMENSIONAL TARGET OBJECTS

(71) Applicant: Kinetic 3D LLC, Kirkland, WA (US)

(72) Inventors: Scott Robert Leatham, Duvall, WA (US); Robert Price de Courcy, Seattle, WA (US)

(73) Assignee: Kinetic 3D LLC, Kirkland, WA (US)

(21) Appl. No.: 18/599,140

(22) Filed: Mar. 7, 2024

Related U.S. Application Data
(60) Provisional application No. 63/450,907, filed on Mar. 8, 2023.

(51) Int. Cl. B29C 64/364; B29C 64/124; B29C 64/321; B29C 64/357; B29C 64/386; B29L 31/00; B29L 31/14; B33Y 10/00; B33Y 30/00; B33Y 50/00; B33Y 80/00

(52) U.S. Cl. CPC B29C 64/364; B29C 64/124; B29C 64/321; B29C 64/357; B29C 64/386; B33Y 10/00; B33Y 30/00; B33Y 50/00; B29L 2031/14; B29L 2031/7132; B33Y 80/00

(57) ABSTRACT

Pressure Delivered 3D Dynamic Printing (PD3DP) comprise 3D printing wherein the polymerizable material (typically a resin) is delivered under positive pressure as each layer of a target object is built/printed. Such positive pressure can be applied intermittently and even reversed to provide a cyclical application of the pressure to assist delivery of the resin, placement of the resin at locations suitable for the shape of the target object, curing of the resin, and releasing of the target object from the projection place between printing of successive layers.

### CROSS-REFERENCE TO RELATED APPLICATIONS

The present application claims the benefit of copending U.S. Provisional Patent Application Ser. No. 63/450,907, filed Mar. 8, 2023, which application is incorporated herein by reference in its entirety.

### BACKGROUND

3D printers, which digitally print 3D target objects, are commonly available. Examples of such 3D printers include Stereolithography (SLA) and Digital Light Processing (DLP) printers, collectively referred herein as SLA 3D printers. Such SLA 3D printers produce 3D target objects by using a laser or other energy source to cure photosensitive liquid resins. SLA printers can typically make high resolution 3D target objects with superior surface quality compared to conventional Fused Deposition Model (FDM) 3D printers, which typically make 3D target objects by extruding solid polymer filament. Other 3D printers/3D printing methods include Selective Laser Sintering (SLS) printing, which uses a laser to fuse suitable powders held in a powder bin, similar to the liquid polymer printing vat used in SLA printers including SLA-Laser printers, multi-jet fusion (MJF, such as a HP MJF), Selective Laser Melting (SLM) and Direct Metal Laser Sintering (DMLS). These and other exemplary 3D printing systems are generally discussed at https://www.hubs.com/knowledge-base/material-processes-explained/. (Various references are set forth herein that discuss certain systems, apparatus, methods and other information; all such references are incorporated herein by reference in their entirety and for all their teachings and disclosures, regardless of where the references may appear in this application. Citation to a reference herein is not an admission that such reference constitutes prior art to the current application.)

3D printing systems typically have preexisting, permanent printing tanks, trays, or vats in the build arena. (Collectively herein, “preexisting printing vat.” Also, “printing vat” in this context indicates a vat, tray, tank, etc., in which the 3D printing takes place, as opposed, for example, to a preexisting permanent reservoir, vat or tank (herein after, “supply reservoir”). Further, “printing arena” indicates an area where 3D printing takes place, and a “vat-less printing arena” indicates a printing arena that does not have any preexisting, permanent printing vat.) 3D printing systems typically have the supply reservoir operably connected to the preexisting, permanent printing vat in the 3D printer, which supply reservoir holds and provides resin or other 3D-printing material to the preexisting, permanent printing vat in which to build the target object. Such 3D printers suffer from one or more of lack of precision, waste of materials, waste of components, limits on the type of materials that can be used, excessive and expensive post-processing, or other disadvantages.

Thus, there is an unmet need for 3D printing devices, systems, methods, etc., that increase precision, speed, reduce waste of materials and/or possibly expand the type of materials that can be used, for example when compared to those 3D printers requiring preexisting, permanent printing vats in which to build the target object such as SLA 3D printers. The present systems, processes, and methods, etc., provide solutions to one or more of these needs, and/or one or more other advantages.

### SUMMARY

Discussed herein are devices, systems, processes, methods, etc., (including exemplary controls, materials, and specifics of the apparatus) for a continuous 3D print system that incorporate a Pressure Delivered 3D Dynamic Printing (PD3DP) process to dynamically print product(s)/target object(s). In some embodiments, the target objects have enclosed perimeters (i.e., a perimeter of the target object that is fully encircling (e.g., a circle, oval, variable radius (even positive and negative radius), multiply-variant shapes, and other encircling patterns), and the PD3DP can be performed without any pre-existing vat or immersion container in the printing arena. In some embodiments, a dynamically-printed lip, for example about 2 mm high, can be incorporated in the first or very early layer of the printing process. For example, it can be incorporated where it is desired to print non-encircling target objects, and if desired a dynamic shell or other encircling structure can be built contemporaneously with, and typically encircling, the target object in the printing arena.

In the methods, etc., herein, positive, and typically negative, pressure are applied to the resin in the printing arena at the level of a newly printed “slice” of the target object, which pressure can be applied, if desired, at the point of extrusion if extrusion is present. Such processes, etc., produce in a layer-by-layer fashion three-dimensional object. Each layer of uncured material is formed under positive pressure prior to cure without a preexisting vat or any other immersion container if desired. In other words, the 3D dynamic product/target object is printed directly by the 3D printer in an open printing arena with positive pressure applied to the new resin via a build plate or other pressure device, and without requirement for a preexisting vat or other permanent immersion pool of resin or other printing material in the build arena in which the 3D dynamic product is created (including the preexisting vat or other permanent immersion pool wholly or partially within the build arena).

The positive and/or negative pressure are applied to the resin intermittently, typically cyclically in a layer-by-layer fashion. The pressure is useful, for example, to move or place resin (or other 3D printing material) at desired locations within the build arena, particularly at the current layer being cured and built. In some aspects, a pressure projection panel disposed between the curing energy source and the resin presses against/applies positive pressure to the resin, directly or indirectly, because either the pressure projection panel or the resin is moved toward each other-either or both can move. Similarly, the pressure projection panel retracts from/applies negative pressure to the resin, directly or indirectly, because either the pressure projection panel or the resin is moved away from each other-either or both can move. The positive and negative. The pressure can also be applied, positively or negatively, by positive or negative flow directions from a pump(s) supplying resin to the build arena and/or current layer being built. Such positive or negative flow directions can be achieved, for example, by a reversible pump or switching between two pumps having opposed pumping directions.

Pumping forces the first layer to coat the build plate with resin. In some embodiments, the polymerizable liquid is the same material delivered to the build plate or subsequent part under consolidation pressure from the build plate pressing resin against the projection plane that can be, for example, between about 65 and 65000 Pascal. The desired pressure is based on material properties, design geometry and the PD3DP apparatus, amongst others. The second (or later) layer forms an interphase boundary that is polymerized by the ultraviolet energy that is delivered. Building one layer on another with the layer delivered under positive pressure, typically because of movement of the build plate can provide a selected layer thickness between about 20-1000 microns, and typically the 3D object is continuously fabricated layer-by-layer. The second (or later) layer can be the same or a different material to produce multi-material target objects. Each layer is delivered under pressure to determine composition and layer thickness. Typically, the pressure is applied to every layer in the dynamically created target object, however in certain embodiments the pressure can be omitted for one or more layers. Each layer is crosslinked via UV or other energy-initiated photo initiator, which can be provided by a laser or other energy source. Typically, the layers of printing material do not form a completely bonded interface with one another solely due to the pressure. At the interface layer, since the thickness and UV energy can be tunable, a user can selectively control build speed.

Through resin pumping volume and speed to the build arena one can reduce or eliminate discontinuities, voids, cleavage lines and other anomalies that will impact the part quality. Conversely, with the pressurized PD3DP systems and methods herein it is also possible to deliberately, selectively incorporate discontinuities, cleavage lines, voids or other features should the design benefit from these for performance and application purposes.

The present devices, systems, processes, methods, etc., include one or more of the following aspects, embodiments and/or features:
A projection panel, which is a thin, flat panel or plate made of glass, transparent Teflon® (polytetrafluoroethylene) or other suitable material having suitable flexibility, transparency and friction characteristics such that curing energy can traverse the panel to cure the resin (or other material) on the opposing side and such that the resin can flow across/against the projection panel during PD3DP printing and during pressure pumping of the resin including higher pressure pumping.
Directly pumping resin between the build platform and projection panel at relatively high positive pressure compared to ambient, such as 70, 100, 200, 500, 1000, 10000, 50000, 100000 or 140000 Pascals, enables greater accuracy, quality, and speed. Conversely, vacuum can be applied to assist to reduce the time to separate the layer from the projection plate and stabilize resin movement.
No need for a wiper while still keeping the projection panel clear of debris and bubbles. This can be advantageous, for example, because wipers typically run very slowly so as to not remove too much material. However, in some embodiments a wiper can be included in the system or process, for example to create a preferred surface on the target object.
Quick replenishment of resin for a new layer, which increases printing performance and reduces print time.
Hydraulic power assists for separation of the target object from the projection panel after a given layer is printed. This can be advantageous, for example, to cause less damage to the target object and the system while printing.
Moving or maintaining a small amount of resin across the projection panel at substantially all times, thereby reducing or eliminating adhesion.
Textured projection panels for some embodiments, for example to create relief patterns on the final top surface of the 3D dynamically printed product/target object.
Projection panels can be swapped as desired, up to each layer if desired.

In the PD3DP processes, systems, etc., herein, pressure is applied on the delivered layer of a polymerizable material (typically a resin in the form of a liquid, paste, etc.) that is subsequently irradiated through the projection plane. The resin then forms a three-dimensional object within the build arena. Thus, in certain aspects the PD3DP processes, systems, etc., print the target object by delivering resin to the build arena that is selectively, controllably pressured by the projection plate during the printing process. Irradiating the build region or arena is typically accomplished through an optically transparent surface (typically the projection plate) to form a solid polymer for the polymerizable material while repeatedly adding layers to the surface of the target object and pressurizing the resin via the projection plate, consolidates and determines the delivered material thickness (the remainder is squeezed from the side of the part and will return to the resin vat).

In some aspects, the present systems, devices and methods, etc., provide Pressure Delivered 3D Dynamic Printing (PD3DP) systems having a pressure projection panel disposed between a curing energy source and an inlet port for a 3D-printing material in a build arena, and can comprise computer-implemented programming to selectively, cyclically press the pressure projection panel and the 3D-printing material against each other and release from each other in the build arena in coordination with layer-by-layer printing of at least one target object in the build arena. The build arena can comprise a build plate at an opposing side of the build arena opposed to the pressure projection panel, the projection panel and the build plate being controllably, selectively moveable relative to each other in a z-axis in a layer-by-layer fashion according to instructions provided to at least one of the projection panel and the build plate, and wherein the projection panel can selectively apply at least one of positive pressure and negative pressure to the resin according to the instructions as the resin can be applied to a layer of a target object being printed in the build arena.

The system can selectively apply both the positive pressure and the negative pressure. The computer-implemented programming can selectively apply pressure to create an immersion field within at least one of the target object or an encircling shell fully encircling the target object, wherein the immersion field can contain liquid 3D printing material up to at least about a top of the target object or encircling shell, and the computer-implemented programming can selectively apply pressure to create a perimeter bead of liquid 3D printing material at a top of the immersion field, the perimeter bead of in place by surface tension and selectively direct a 3D print pattern from the curing energy source to a top of the 3D printing material, such as a directing a 3D print pattern from the curing energy source to a top of the 3D printing material in a step-wise fashion to successively build the target object in a layer-by-layer fashion.

The inlet port can traverse through the build plate, and the pressure projection panel can be transparent, pliable, and low-friction. The 3D printing material can be a liquid photosensitive resin that cures into a solid when struck with a suitable activation light from the curing energy source. The curing energy source can be a light delivery source, ultraviolet light delivery source, a heat delivery source, an iris focused thermal radiation source, and the PD3DP system can comprise a thermal management system for rapid cooling and heating by the thermal radiation source. The curing energy source can be an electron beam source and can be non-visible directional energy.

The computer-implemented programming can contain instructions combining pressure applied to the 3D printing material, layer thickness, energy delivered to uncured 3D printing material, timing of build plate release from the pressure projection panel. The PD3DP system can comprise a reversible pump to deliver the 3D-printing material to the build arena, and the computer-implemented programming can control the reversible pump to deliver resin at a controlled micrometer level to the build arena and can control resin delivery by the reversible pump to control pressure within the 3D printing material.

The PD3DP system can comprise a 3D printing material catchment system to catch and redeploy unused 3D printing material. The computer-implemented programming can instruct the pressure projection panel to press against the 3D-printing material after a layer of the 3D-printing material can have been introduced into the build arena and before directing curing energy to the new layer of 3D-printing material.

The build plate can be moved toward and away from pressure projection panel as a part of delivery of 3D-printing material to the build arena and release of cured 3D-printing material from the pressure projection panel, and the positive pressure and the negative pressure can be implemented by applying or reversing the direction of flow of 3D-printing material into the build arena. The system PD3DP can lack a preexisting printing vat or permanent printing vat in the build arena. The PD3DP system can hold in the build arena at least a partial dynamically printed target object printed by the PD3DP system.

The computer-implemented programming can comprise instructions to print a target object, and to print a target object and not to print any surrounding structure. An outer surface of the target object can have no unintended bumps, flashing or ridges extending more than 0.1 mm from the outer surface, and the outer surface of the target object can have no surface artifact extending more than 0.01 mm from the outer surface.

The computer-implemented programming can comprise instructions to print a target object within an encircling shell fully encircling the target object, including where dynamically created, non-vertical guywires hold the target object to the encircling shell. The dynamically created, non-vertical guywires can be about 200 μm or less in diameter. The encircling shell and the target object can be made of a same 3D printing material or can each contain different 3D printing materials. The encircling shell further holds at least one dynamically created auxiliary structure. The auxiliary structure can comprise a plumbing that conducts printing material from a first location within the encircling shell to a second location within the encircling shell. The PD3DP system can be in process of building the target object.

The 3D printer system can comprise a top down or bottom up stereolithography (SLA) or digital light projection (DLP) system capable of 3D printing the target object from a photosensitive liquid resin. The PD3DP system can contain a plurality of inlet ports supplying 3D printing material to the encircling shell, each inlet port supplying a different or same 3D printing material. The different 3D printing materials can be different photosensitive resins. The pressure projection panel can be made of at glass or transparent polytetrafluoroethylene.

The computer-implemented programming can comprise instructions to pump resin between the build platform and the pressure projection panel at a positive pressure of about 70 to 140000 Pascals. The PD3DP system can have or not have a wiper and can comprise a projection panel cartridge can comprise a wiper. The projection panel cartridge can be removable. The PD3DP system can comprise at least two projection panel cartridges, one having a wiper and without a wiper can be removable.

In some aspects, the present systems, devices include methods that can comprise manufacturing or using a PD3DP system as shown herein.

Some aspects include target objects printed by a Pressure Delivered 3D Dynamic Printing (PD3DP system as shown herein. The target object can be located within or outside of the PD3DP system. The target object can be located within an encircling shell within the PD3DP system. The target object can have no unintended bumps, flashing or ridges extending more than 0.1 mm from an outer surface of the target object.

The target object can be an open shell such as a drink glass, or can be a closed shell, or a filter.

In some aspects, the present systems, devices include methods that can comprise layer-by-layer printing a target object via Pressure Delivered 3D Dynamic Printing (PD3DP) comprising:
a) providing a PD3DP system; and,
b) PD3DP printing a target object within the PD3DP system,
wherein the PD3DP printing can comprise selectively, intermittently pressing and releasing a pressure projection panel against uncured 3D-printing material in a layer-by-layer fashion to assist in building the target object.

The computer-implemented programming can instruct the pressure projection panel to press against the 3D-printing material after a layer of the 3D-printing material can have been introduced into the build arena and before directing curing energy to the new layer of 3D-printing material, and can instruct the pressure projection panel to be pulled away from the 3D-printing material after the directing of the curing energy to the new layer of 3D-printing material. The build plate can be moved toward and away from pressure projection panel to implement the pressing against and releasing of the pressure projection panel and the 3D-printing material.

The methods further can comprise printing guywires connecting the encircling shell and the target object, and printing at least one auxiliary structure within the interior space of the encircling shell. The methods further can comprise removing the target object from the PD3DP system or removing the target object from the encircling shell. The system can comprise a reversible pump and the method further can comprise reversing the reversible pump prior to directing curing energy to the new layer of 3D-printing material. The reversible pump prior can be a micro-metering reversible pump.

The current systems, methods, etc., herein are discussed in greater detail with reference to accompanying drawings and embodiments below. The PD3DP in which pressure is delivered at the projection plate may be embodied in many different forms; the embodiments herein are provided as a template and are in no way a complete representation of all aspects of the idea. For example, in some embodiments the current systems, methods, etc., herein provide a removeable physical projection panel and eliminate any need for a wiper.

These and other aspects, features and embodiments are set forth within this application, including the following Detailed Description and attached drawings. Unless expressly stated otherwise, all embodiments, aspects, features, etc., can be mixed and matched, combined and permuted in any desired manner. In addition, various references are set forth herein, including in the Cross-Reference To Related Applications, that discuss certain systems, apparatus, methods, and other information; all such references are incorporated herein by reference in their entirety and for all their teachings and disclosures, regardless of where the references may appear in this application. Such references are not necessarily prior art to the current application.

### BRIEF DESCRIPTION OF THE DRAWINGS

FIGS. 1A to 1C depict front plan and perspective views of a Pressure Delivered 3D Dynamic Printing (PD3DP) system as discussed herein.

FIGS. 2A to 2B depict front plan and perspective views of a further Pressure Delivered 3D Dynamic Printing (PD3DP) system as discussed herein.

FIGS. 3A-3F depict a high-level flowchart of an exemplary pathway to conduct a Pressure Delivered 3D Dynamic Printing (PD3DP) process using the systems, methods, etc., herein.

FIG. 4 depicts a cutaway side view of a built arena and certain related structures of a Pressure Delivered 3D Dynamic Printing (PD3DP) system as discussed herein.

FIG. 5 depicts a cutaway side view of a build arena and certain related structures of a Pressure Delivered 3D Dynamic Printing (PD3DP) system as discussed herein wherein a projection plate is positioned to build the first layer of a target object.

FIG. 6 depicts a cutaway side view of a build arena and certain related structures of a Pressure Delivered 3D Dynamic Printing (PD3DP) system as discussed herein wherein a first layer of the target object is exposed by the light source through the projection plate.

FIG. 7 depicts a cutaway side view of a build arena and certain related structures of a Pressure Delivered 3D Dynamic Printing (PD3DP) system as discussed herein wherein separation of a newest layer from the projection plane is illustrated.

FIG. 8 depicts a cutaway side view of a build arena and certain related structures of a Pressure Delivered 3D Dynamic Printing (PD3DP) system as discussed herein wherein the build plate is positioned to produce the nth layer of the target object.

FIG. 9 depicts a cutaway side view of a build arena and certain related structures of a Pressure Delivered 3D Dynamic Printing (PD3DP) system as discussed herein wherein the final layer of the target object is being separated from the projection plate.

FIG. 10 depicts a cutaway side view of a build arena and certain related structures of a Pressure Delivered 3D Dynamic Printing (PD3DP) system as discussed herein wherein the final object and shell are removed manually by hand or by robotic apparatus.

FIG. 11 depicts an exemplary overall process flow for a Pressure Delivered 3D Dynamic Printing (PD3DP) system through a series of charts.

FIG. 12 depicts exemplary high-level printer software logic for a Pressure Delivered 3D Dynamic Printing (PD3DP) process using the systems, methods, etc., herein.

FIG. 13 depicts further exemplary high-level printer software logic for a Pressure Delivered 3D Dynamic Printing (PD3DP) process using the systems, methods, etc., herein.

FIGS. 14A to 14C depict a series of drawings illustrating an open-shell print process for a Pressure Delivered 3D Dynamic Printing (PD3DP) system as discussed herein.

FIGS. 15A to 15C depict a series of drawings illustrating a closed-shell print process for a Pressure Delivered 3D Dynamic Printing (PD3DP) system as discussed herein.

FIGS. 16A to 16D depict a series of drawings illustrating a close up of a closed-shell print process for a Pressure Delivered 3D Dynamic Printing (PD3DP) system as discussed herein.

FIGS. 17A to 17B depict a hollow pyramid target object with target object break off tubes and manifold illustrated in detail from a Pressure Delivered 3D Dynamic Printing (PD3DP) system as discussed herein.

FIGS. 18A to 18C depict a drinking glass printed from resin delivered from the main resin inlet in the vertical direction to the immersion field from a Pressure Delivered 3D Dynamic Printing (PD3DP) system as discussed herein.

FIGS. 19A to 19B depict drinking glass shown in different states of the print process of a Pressure Delivered 3D Dynamic Printing (PD3DP) system as discussed herein.

FIG. 20 depicts resin pumped through the build plate to the immersion field for a manifold, being subjected to applied pressure by the projection plane and creating the resin field base support for a Pressure Delivered 3D Dynamic Printing (PD3DP) system as discussed herein.

FIGS. 21A-21B depict a filter made by a Pressure Delivered 3D Dynamic Printing (PD3DP) system as discussed herein.

FIG. 22 depicts Pressure Delivered 3D Dynamic Printing (PD3DP) system having a wiper as a part of a projection panel cartridge.

FIG. 23 depicts Pressure Delivered 3D Dynamic Printing (PD3DP) system having a wiper as a part of a projection panel cartridge.

### DETAILED DESCRIPTION

The present systems and methods, etc., comprise PD3DP printing wherein the polymerizable material (typically a resin) is delivered under positive pressure as each layer of a target object is built/printed. Such positive pressure can be applied intermittently and even reversed to provide a cyclical application of the pressure to assist delivery of the resin, placement of the resin at locations suitable for the shape of the target object, curing of the resin, and releasing of the target object from the projection place between printing of successive layers.

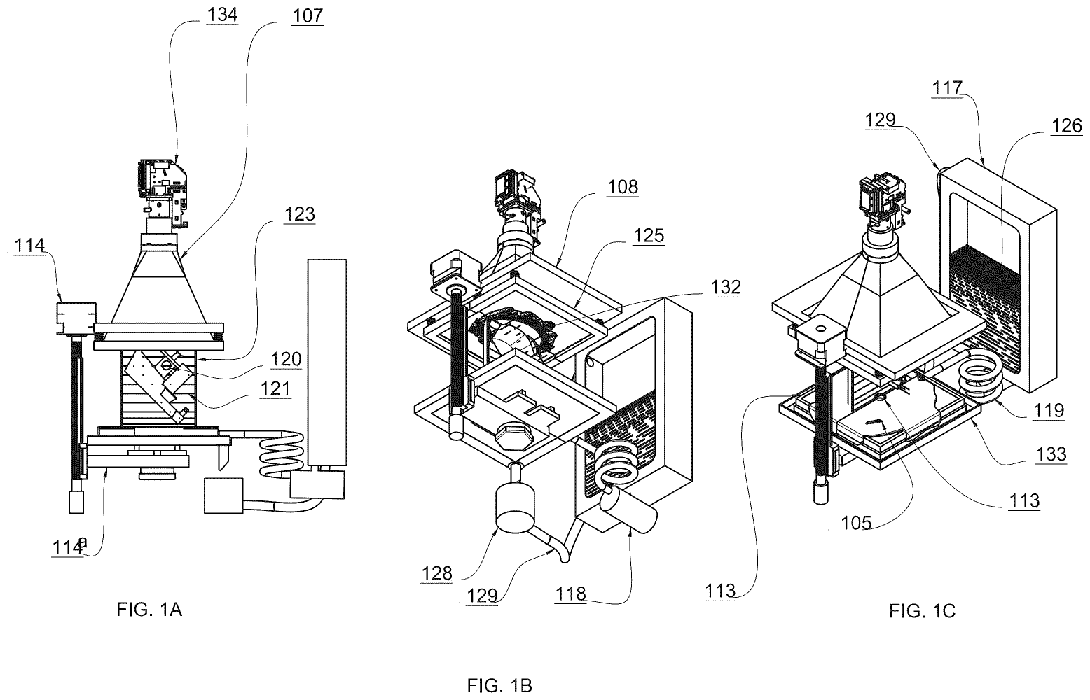

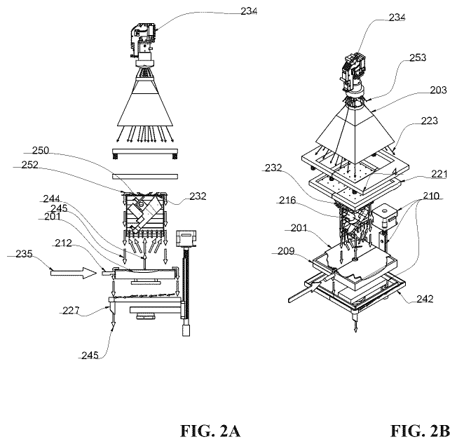

FIGS. 1A-1C and 2A-2B, and other figures herein, depict examples of systems and methods herein including those in which an immersion field is formed. In these examples two 3D dynamically-printed products are produced simultaneously in the build arena, each of which in these examples has exterior surfaces of consumer quality finish after the build and typically without post-processing, i.e., smooth surfaces having substantially no significant surface artifact such as undesired bumps, flashing, ridges, etc., from resin squeezing out from the build process greater than 0.1 mm, 0.01 mm, or even 0.001 mm; “undesired” here means unintended/not a part of the input design.

In FIG. 1, polymerizable resin from reservoir (117) is pumped by the resin delivery pump (118) through resin delivery tube (119). It arrives on and is pumped onto the build plate, sometimes called a build platform (113). The resin can flow over the sides of the build platform (13) and collects in resin return system (128) and is transported back to the resin reservoir via return tube (129). The resin on the build platform is approached by the projection panel (125) via the Z-axis motor (114), positive pressure is applied by lowering the projection panel (125) onto the resin. This may force resin out along the sides (132). The projection panel (125) is controlled by pressure control springs (18), and the target object or part is formed by projecting an image or print pattern down from the light source such as projector (134) (or other suitable energy source) to produce an outer 3D enclosure, guy wire horizontal supports, and inner 3D dynamically-printed product (tug boat in this example) by projecting UV energy (134) through the projection light shroud (17).

In FIG. 2, another view is shown that depicts resin being delivered to the build arena for shell and object creation (244) from the build plate or platform (209), the resin flowing through the spout (245) to the build plate (209) and over the side (201) into the gutter (242). The build plate (209) is supported on the Z-axis positioning system (210). The projection panel (221) is mated with a projection panel mount (24) made from FEP or other material whereby the projection panel meets and applies pressure to the top of the shell (250), surface tension confining resin at the top of the shell (232) with excess resin flowing down the side of the shell (252). The projector (234) light is collimated, and a light pattern is projected (223, 253) and projects through the light shroud (203) to the projection panel (221) onto the build plate (209) where the outer 3D dynamically printed product and supports are created, and the shell (232) is filled with resin (216).

An exemplary printing process is depicted in block diagram A-I (FIG. 3), and a discussion of exemplary materials and sequence of operation are shown in the following paragraphs (and elsewhere herein).

In FIG. 3A: the initial steps to begin a print are outlined including lowering the build plate, loading the desired code, and pumping resin or similar material to the build plate creating a “free standing pool” that is retained by surface tension at the edges of the build plate.

FIG. 3B: the projection plane is positioned at some distance off the build plate. This is typically between 1-100 micron. The immersion field is now the leftover pool of resin that has been pressurized down to a single layer thickness.

FIG. 3C: The resin is allowed to settle.

FIG. 3D: The resin layer is exposed to a slice pattern for a predetermined time duration.

FIG. 3E. The separation process includes moving the build plate down some level (usually 1000-5000 um) below the previous layer. At this time resin is simultaneously pumped to release vacuum and assist in layer release.

FIG. 3F: The build plate is raised below the previous layer height, usually between 1-4 um. In parallel, the pump is reversed to remove resin and relieve pressure.

FIG. 3G: The resin is allowed to settle.

FIG. 3H: The resin is exposed to the layer slice pattern.

FIG. 3I: The process returns to step D, resin exposed, and the next layer is created.

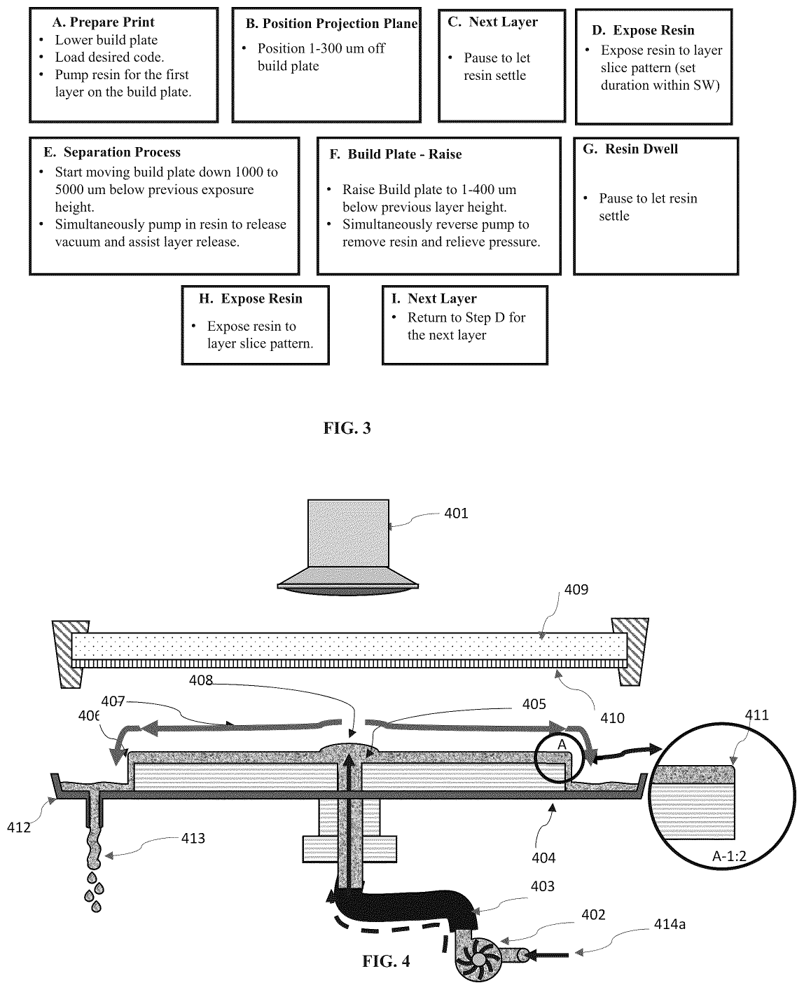

An exemplary version of the overall process is also depicted in FIG. 4-10.

In FIG. 4, the first layer is prepared for deposition. The light source (401) is above the clear backing plate (409) with an anti-friction coating or laminated film on the bottom (410). Resin is pumped from the metering pump (402) towards the build plate (414a) via an inlet tube coming up into the build arena forming a coating of resin (408) and flowing across the build plate (407), over the edges (406) downward via gravity into the gutter (404) where it drops through an outlet (412) and drains (413) into a catchment or reservoir (not shown). Resin passes through the build platform—for example, via internal tubing and may be treated by a heat management system to maintain optimal operational temperature specific by the resin manufacture. Resin flows on the build platform as described forming a layer resin, the thickness of which is a function of the resin's physical characteristics such as surface tension and viscosity and other factors, thus making the first layer of the 3D dynamically printed products.

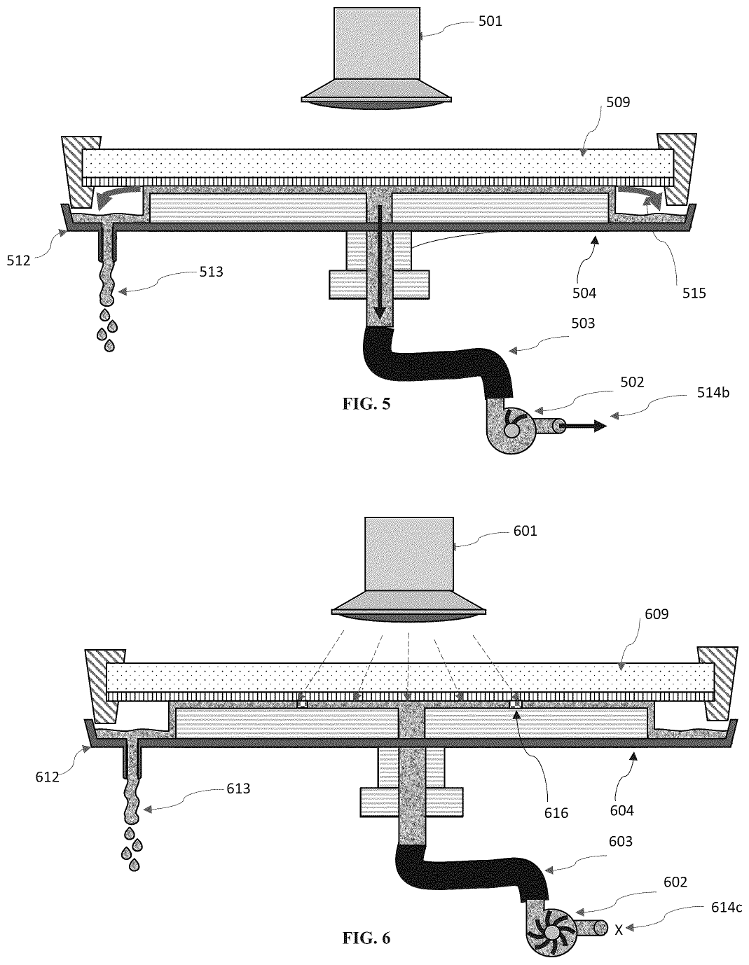

In FIG. 5, the layer resin thickness is set prior to curing (polymerization). Layer thicknesses can be set as desired, for example typically between 1 um up to 100 um, and layers of up to 200 um or more can also be used for faster output. The system build plate is positioned at an appropriate distance from the projection plane to form the first layer. The projection plate is positioned to build the first layer. Pressure is applied as the build plate (509) is raised until it presses against the projection plate (510) which can be a glass plate or other suitable friction and transparency characteristics relative to the light source and resin. Resin is pumped into the build arena between the build platform and the projection panel and in doing so forces resin down into the metering pump (502) reversing the direction of the resin back into the reservoir (514b). In addition to providing a layer of the 3D dynamically printed products, the pressure can force bubbles and debris out of the build arena.

In FIG. 6, the first layer is exposed by the light source (601) through the clear projection plate with the resin flow blocked by immobilizing the pump (614c) and curing the first layers (616). The images of the first (or subsequent) layer of the 3D dynamically printed product is projected forming a desired shape, which includes the target object, and can include resin filled shell, one layer thick. Resin and/or energy source can be selected to cure-harden at the light spectrum of the projector. For example, the wave number of 405 nm is used for many SLA/DLP resins. A small amount of residual pressure helps to reduce or effectively eliminate adhesion of the newly formed later to the projection panel.

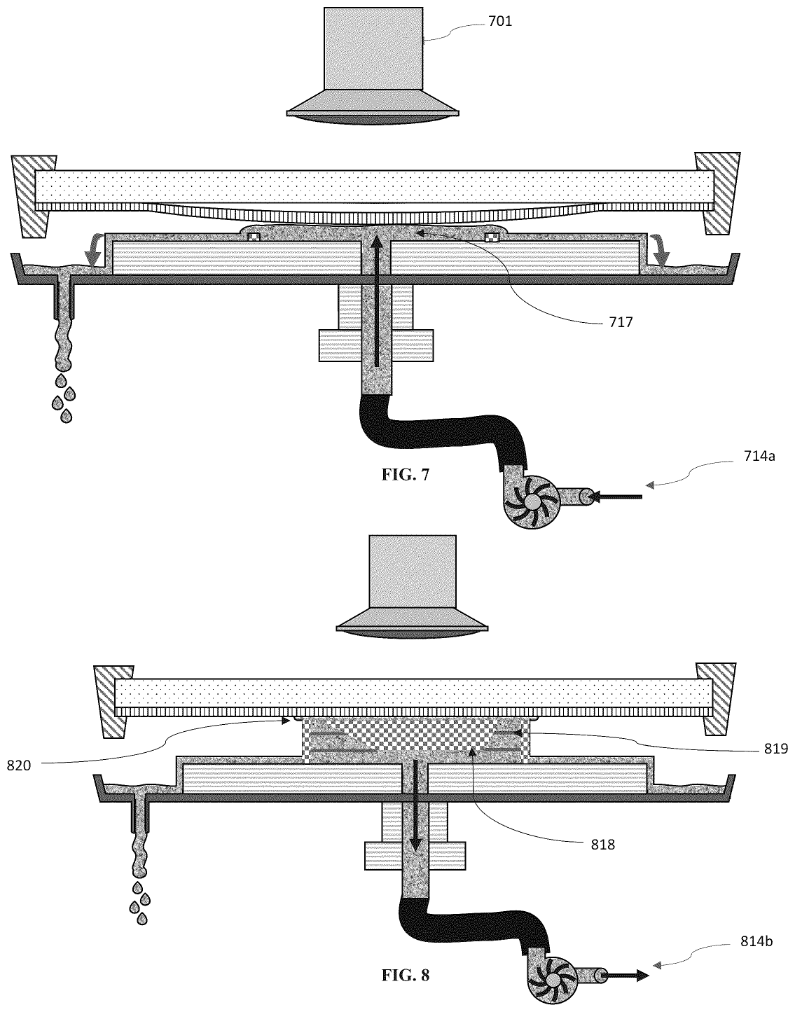

In FIG. 7, the separation of layer from the projection plane is illustrated. During the separation phase the build plate is lowered along the Z-axis a short distance (herein, “lowered” and “raised” and the like are used to indicate increasing or decreasing the relative distance along the z-axis of the projection panel and the build plate) to separate the flexible (or non-flexible depending on the resin use) projection plane from the cured resin layer (717). During such lowering, resin can be pumped into the build arena to assist with the separation of the projection panel and the 3D dynamically printed products, which can be particularly helpful if some adhesion of the 3D dynamically printed products to the projection panel has occurred. Layer thicknesses can be set as desired, for example typically between about 1 um, 3 um, 5 um, 10 um, 25 um, 50 um up to about 100 um, and layers of up to 200 um or more can also be used for faster output. The upwelling of resin being pumped in (714a) as the build plate is lowered assists in high-speed separation and reduces wear and risk of damage to the projection plate via hydraulic counter pressure. Pressure instrumentation and volume calculations can be used to reduce displaced resin via pressure or vacuum. The result is a resin column that maintains contact with the projection plate with minimal to no spillover. It also protects the print itself from vacuum or cupping effects. Alternatively, excess resin can be pumped in order to displace bubbles, or debris from the build arena.

In FIG. 8, the build plate is positioned to produce the Nth layer of the part/target object (818). In this figure and embodiment, the target object (a ship) (818) is formed simultaneously, layer by layer, with a surrounding dyna-shell (820). In other embodiments, particularly where the target object is an encircling shape, the dyna-shell (820) can be omitted. The target object (818) in FIG. 8 is supported by horizontal guywires (819) that attach between the inner shell wall and the target object (818). Other supports such as vertical supports to the build plate, or diagonal supports attaching from the inner shell wall to the target object can also be produced.

In FIG. 8, an immersion field of resin can be created over the top of and around the outside of the perimeter of dyna-shell (820) thus creating a perimeter bead of resin held in place by surface tension. Typically, the bead extends beyond the perimeter approximately 0.5-5 mm based on the resin viscosity. This will depend on the chemical characteristics of resin and projection plate and environmental conditions in the build area such as temperature. The next layer can be formed in this immersion field if desired. Resin continues to be pumped under pressure into the build arena as the build platform is raised to the previous position minus the desired layer thickness. Such thickness can be induced by the hydraulic ram effect of the Z motor pressing the target object against the projection plate. Reducing pressure allows for faster Z movement and acceleration along with shorter settling times. This pumping of resin can be configured to remove and even eliminate debris, air bubbles and other unwanted materials, for example by displacing extra resin. The dyna-shell (820) remains filled with resin. Extra resin pumped into the system ultimately flows into a catch gutter and then to the resin return system (814b). If desired, such resin can be passed through a filter and back into the reservoir for reuse. By virtue of the perimeter bead of resin, the outer perimeter dimensions of the next layer geometry can be increased by as much as the bead perimeter radius, thus giving the object design engineer the capability gradually form larger layers horizontally.

In FIG. 8, the target object is supported by horizontal guywires that attach between the inner shell wall and the target object. Other supports such as conventional vertical supports built from the bottom up, or diagonal supports attaching from the inner shell wall to the target object can be produced.

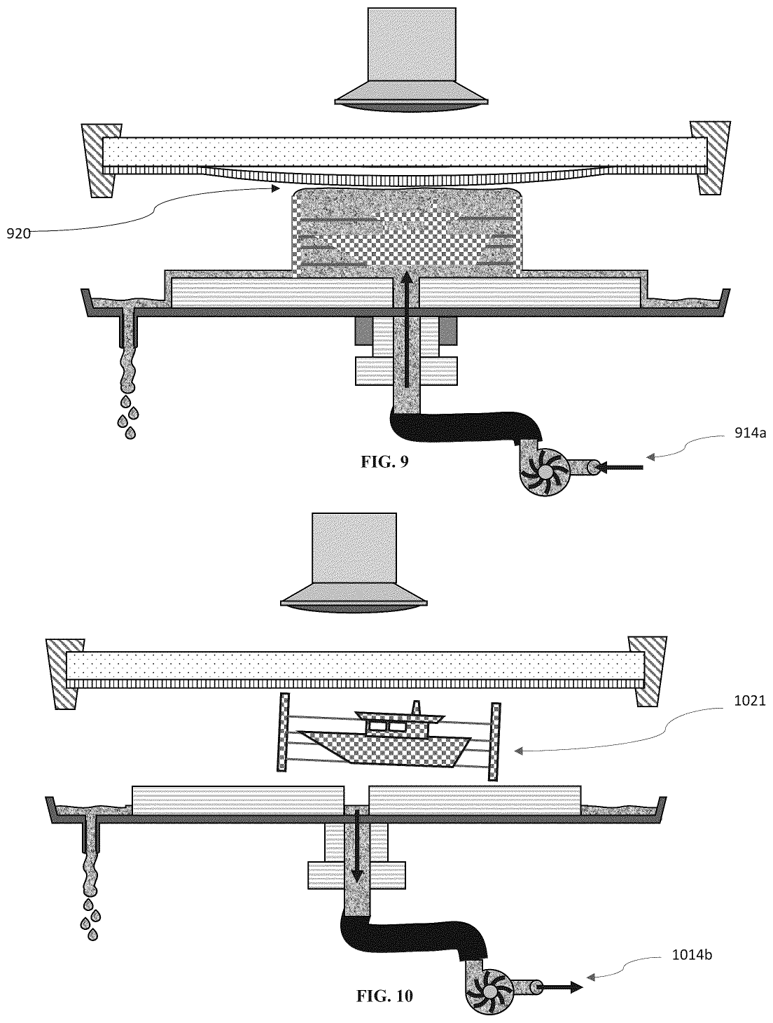

FIG. 9 illustrates the separation of the final layer, similar to FIG. 7. Once the printing process is complete, the build platform is positioned to make removal of the 3D dynamically printed products easier. During separation, the semi-flexible projection plane (if appropriate for use with a respective compatible resin) is slightly warped to enable the separation process.

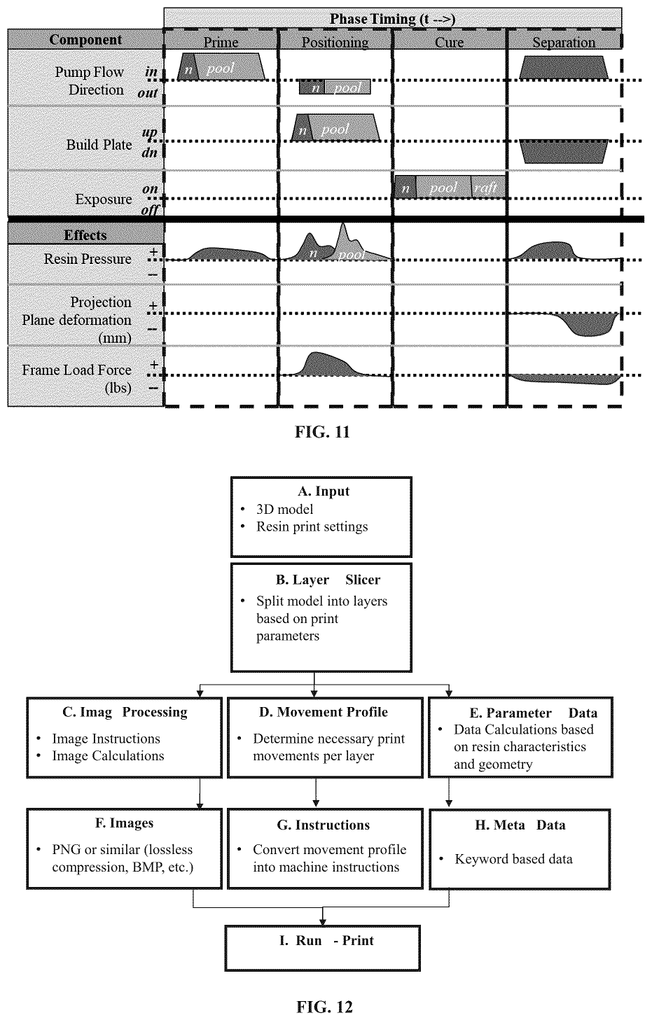

In FIG. 10, the final target object and shell (1021) are removed manually by hand or by robotic apparatus. The PD3DP products (1021) are removed from the build platform, for example by pushing lightly at the bottom of the shell with a flat tool. Strong adhesion by the 3D dynamically printed products and the build platform (build plate) is usually not needed for the build production, nor a problem in this system. To reduce excess resin spillage the pump (2) can be reversed (14b) to drain the resin contained in the dyna-shell. Optionally, cleaning solution can be pumped through the system to remove uncured liquid resin from all surfaces and tubing.

The 3D dynamically printed product(s) including the target object can then go through post-processing if desired, for example to remove supports, then if desired they can be passed forward to washing and final hardening by UV-bath. Where one of the products was an encircling shell (sometimes called a dynamic shell) or other suitable shape, such products can be reused in future printing processes if desired by installing a printer of the compatible design.

In FIG. 11 the overall process flow is illustrated through a series of charts. For example, when the pump is turned on and resin flows, the positive pressure on the resin is low. When the build plate is brought up to the projection plane, resin pressure increases and the frame is under positive load pressure. Pump flow direction can be reversed at this stage. Cure takes place in the next phase followed by separation where the flow direction is again reversed to positive, the build plate is reversed, and the resin pressure and frame load is unloaded.

Exemplary PD3DP software logic is set up in FIG. 12.

In FIG. 12A the slicer takes a 3D model file as input. Resin specific parameters such as viscosity, cure power, elasticity, max pump speed, layer height, etc. are also set automatically or manually depending upon printer configuration.

In FIG. 12B the slicer cuts the model into layers corresponding to the static or dynamic layer height settings.

In FIG. 12C The layers are analyzed for printability and appropriate print settings are set based upon layer geometry and parameters from A. Image processing is also done for light uniformity, anti-aliasing and any other digital to analog quality improving methods.

12D the movement sequence for all motors, pumps, solenoids, valves, etc. are set based upon parameters from A

In FIG. 12E the resin parameters A and layer analysis E are interpreted and converted into settings for the machine. These can include max/min projector power, pressures, etc.

In FIG. 12F the images are saved using lossless compression.

In FIG. 12G the calculated movement sequence is converted into instructions and instruction payload. This may include Gcode, STEP, open or closed loop parameters, or other standardized or custom machine interpretable instructions.

In FIG. 12H parameter data is saved as a key base format

In FIG. 12I images, instructions, and metadata are saved into a data payload for the printer.

In FIGS. 13A-C the printer receives data from the slicer through networking or physical data SD/TF, USB, etc.

In FIG. 13D pixel data is loaded to the projector via digital communication such as parallel or serial data communication

In FIG. 13E motor controller interprets instructions and follows the programmed print sequence.

In FIG. 13F miscellaneous print settings are interpreted and used to program various aspects of the layer sequence. Behavior of certain movement commands can be modified, and non-sequential settings can be set such as temperature, pressure limits/targets, and projector power.

The present PD3DP is also discussed herein in greater detail with reference to accompanying drawings and embodiments of the idea are illustrated. These embodiments attempt to convey the scope of the PD3DP systems, methods, etc.,

Turning to some further general discussion of the methods, systems, etc., herein, in certain embodiments of PD3DP the first layer of material is delivered to or in contact with the build plate, produced from any material as there is no need for transparency—the UV energy is delivered from the top down-after positive pressure has been brought between the resin and part. This step can be advantageous for the overall process performance; pressure applied to the delivered resin being supported by the build plate. Therefore, the build plate can have high stiffness and be stationary, with no movement during build. Furthermore, the build plate could be textured, or surface modified to promote adhesion of the first layer, or to preferentially texture the part surface. Final part removal can be considered in this process because, while there will be adhesion of the target object to the build plate, the part ultimately will be removed upon PD3DP print completion.

In some embodiments, pressure applied to the material delivered is an empowering product feature set that will provide both layer control of the delivered material and will consolidate the material layer upon delivery to either the build plate or to the previous material layer. The PD3DP process pressure applied to the fluid layer under compression is governed by the following equation:

$$P = F / A \qquad ( 1 )$$

Where P=Pressure
   F=Normal Force
   A=Area over which the force is applied.

This formula is based on the definition of pressure as force per unit area over which the force is applied. When a fluid is under compression and restrained on the edge by fluid surface tension, the pressure at a particular depth can be calculated as follows:

$$P = {P}_{o} + p g h \qquad ( 2 )$$

Where P=Pressure at a particular depth
   Pₒ=Pressure of the atmosphere
   p=Density of the fluid, viscous material
   g=acceleration due to gravity
   h=depth of material
This indicates there is a material pressure gradient across the material interface as a function of the material depth. Therefore the surface tension that is constraining the material with viscosity “X” under a compressive load is equal to P is the sum of the terms provided above.

Within the PD3DP process, there is an additional term to the overall pressure P; that is, the projection plate provides an applied positive force Pₐ to the build surface after the “as received” material is delivered in-situ to the build plate during the print process of the finished part. The resulting overall pressure P_{T} is the equivalent of the following:

$${P}_{T} = {P}_{a} + {P}_{o} + p g h \qquad ( 3 )$$

Where P_{T}=Pressure at a particular depth
   Pₐ=Pressure applied by the projection plane
   Pₒ=Pressure of the atmosphere
   p=Density of the fluid, viscous material
   g=acceleration due to gravity
   h=depth of material

In the PD3DP process pressure is applied to each layer in the layer-by-layer process. There is no external compressor used; applying pressure upon material delivery is inherent within the 3D build process. In most embodiments the pressure delivered is independent of the fabrication speed. This is due to the process pressure being delivered on the order of milliseconds as a function of the projection panel contact.

In some embodiments, there are multiple channels formed wherein the photo-initiated resin or resins can be delivered under pressure P_{T} through one or more of the channels.

In some embodiments multiple materials can be delivered under pressure P_{T} to the UV energy layer that will comprise a multi-material layer.

In some embodiments, the method may repeat the steps to produce a region that is unique and has different functions than the bulk of the part, delivered under pressure P_{T}.

In some embodiments, multiple materials can be delivered to the build surface or part that are combined under pressure P to give a consolidated part geometry.

In some embodiments, the polymer can be polymerizable by free-radical polymerization.

In some embodiments, the resin or second phase materials can be heated or cooled to promote flow onto the build surfaces-before the projection place applies pressure to the layer.

In some embodiments, the polymerizable liquid is catalyzed in-situ while prior to being exposed to UV or another form of crosslink promotion energy. Chemical reactions that take place in-situ are an example of this in application.

In some embodiments, the catalyzing photo-initiator is added to the uncatalyzed resin prior to subjecting to pressure from the projection plane. These can be cationic polymer and acid-catalyst.

In some embodiments, the pressure applied by the projection plane can be aided with the incorporation of acoustic or ultrasonic energy to aid in the compaction step. Acoustic or Ultrasonic energy can be applied to the material reservoir, to the transport lines or channels, or at the build plate.

In some embodiments, acoustic or ultrasonic energy can be combined within the PD3DP platform to create consolidated, void-free compressed polymeric or composite printed structures, or multi-phase polymeric compounds. Incorporating acoustic or ultrasonic energy at the projection plate can achieve the following; (1) Reduce internal friction that aids composite consolidation; (2) High frequency allows for precise control over the consolidation process, ensuring that the material is properly heated and compacted; (3) Improved mechanical properties-induced high frequency loading improves the mechanical properties of the material, such as hardness and fracture toughness.

Acoustic systems within 3D printing have focused on part consolidation; the approach herein will ensure sufficiently distributed multi-phase systems are prepared prior to the build. Furthermore, acoustic input to the material culminating at delivery can aid in smoothing the part surface—in all parts, whether it be a single resin under photoinitiated cure or multi-phase composites that are built across a wide range of individual layer thicknesses.

Material conditioning via Acoustic or Ultrasonic Energy can aid in-situ mixing and processing of multi-phase material systems. Mixing 3D materials of different phases has always been a challenge. The ability to mix multiple materials in-situ via acoustic energy opens new possibilities in 3D printing. It is possible within this process scope to produce multi-functional materials from such second phases as graphene, carbon nanotubes, or ceramic nanocomposites. This unique high energy mix technique which transfers no energy to the material (it is a mix) will open new possibilities in electronics, aerospace, energy, and medical devices, to name but a few.

In some embodiments, mixing two or more materials within a dynamic mixer (active mixer), such as impellers or blades, that provides mixing, for example between 1, 10, 100, 500, 1000, or 2000 rpm, for materials (some polymers, ceramics, metallics) that need energy to blend. For example, in a print technique that deposits material layer by layer, the ability to dynamically tune (alter) the material form allows for the creation of complex structures and shapes with varying topology and functionality. Using the PD3DP process, accurate parts can be printed/built from 3D CAD data without tooling through the conversion of liquid materials (polymers), carbon-based materials (fibers, sol-gel platelets, whiskers, etc.) and ceramics to composites in solid cross-sections, layer by layer.

In some embodiments that leverage dynamic mixing of multi-materials, new functionality can be developed in battery anode, cathode and stack designs, functional surfaces that include filtration, electronic-induced printed hardware, medical devices with embedded features and functionality, to name but a few.

In some embodiments, a hydraulic separator integrated in-line with a PD3DP printer can function to separate the primary and secondary (or more) material feeds to the print surface “zone” delivering area-specific material properties to a continuous printed part. The hydraulic separator acts as a barrier between loops allowing each to operate independently. The hydraulic separator's primary function is to prevent interference between different materials and improve the overall system efficiency.

In some embodiments, the hydraulic mix primary loop contains the source of one print solution typically at room temperature, though the temperature can be heated or cooled depending upon the print architecture.

In some embodiments, the hydraulic mix secondary loop or loops carry the fluid of a different material than the primary loop to individual zones in the part where these properties are needed. This could be locally cured (UV, heat, etc.) and may be delivered with varying flow rate or pressure depending on the specific zone or system desired. The hydraulic separator alleviates any interference between the flow and pressure of the primary loop and the performance of the secondary loops which could lead to uneven flow, zonal interference, or reduced efficiency. In some embodiments, loops then operate independently by (1) Physically separating flow paths through separate chambers for each loop; (2) Reducing pressure imbalances through equalizing pressure between loops preventing high pressure in one loop from affecting the pressure in secondary loops.

Hydraulic loop separation achieves benefits that include (1) Improved system efficiency because each loop can operate at an optimal flow rate, pressure, mixing; (2) Enhanced system control as individual zones can be controlled more precisely with less interference from other parts of the system; (3) Allow more materials to be used in production and (4) Reduce wear on the single system.

In some embodiments, localized thermal and mechanical performance can be enhanced for the PD3DP printed structure through hydraulic separation. For example, electronic packaging usually has multiple components associated with the overall design, some of which generate higher heat than others. These component locations require higher thermal transport properties and usually consist of a second phase material that has superior thermal conductivity to achieve thermal transport operating parameters. In such cases a second loop material consisting of high thermal conductivity can be delivered preferentially to satisfy design criteria.

Materials that can be utilized by the PD3DP printers and processes are numerous. The range of materials include polymerizable fluids or liquids, catalyzed polymerizable liquids, photocurable silicone, photocurable urethane, hydrogels, ceramic green-state materials, high-performance thermosets, algae-fungi with photocurable binder, photocurable biological materials, and others.

Acid Catalyzed Polymers: Free radical polymerization may be the most commonly used material in the embodiments though acid catalyzed, or catatonically polymerized, polymerizable liquid may be employed. Acid catalyzed polymers are materials that undergo polymerization in the presence of an acid catalyst. These polymers have been used extensively as binders and adhesives due to their excellent performance properties such as high shear strength, low viscosity at room temperature, and good water resistance. They can be formulated with various types of monomers, including acrylics, olefins, styrene-acrylates, vinyl esters, epoxies, urethanes, silicones, and other specialty resins. Acid-catalyzed polymers are suitable for use in PD3DP printing applications because they offer several advantages over traditional thermoplastics. Typically, an ionic or non-ionic photoacid generator is included in the acid catalyzed polymerizable liquid that could include, but are not limited to sulfonium salt, iodonium salt such as triphenylsulfonium hexafluorophosphate, diphenyl iodide hexafluoroarsenate, etc. Additionally, these polymers can be easily modified by changing the type or amount of crosslinking agent allowing for fine tuning of the final material's properties. Some specific examples of acid catalyzed polymers include (a) Poly(methyl methacrylate) (PMMA); (b) epoxy resins and (c) silane derived polymers containing reactive groups that can react with hydroxyl (—OH), carboxyl (—COOH), or amino (—NH2) functionalities on surfaces.

Photocurable Urethane: Photocurable polyurethanes can be cured using ultraviolet (UV) or visible light with a composition that typically consists of urethane monomers, photo initiators, chain extenders, antioxidants and crosslinkers. Urethane monomers provide the backbone structure, while photo initiators initiate the curing process upon exposure to UV light. Crosslinkers help create a network within the polymer, enhancing its mechanical properties. Photocurable polyurethanes have many applications including (1) Medical Devices including printed scaffolds for bioprinting and tissue engineering, as well as implantable medical devices like heart valves and orthopedic implants; (2) Bioprinting to produce organs like livers and kidneys, and even cells and bacteria cultures; (3) Tailored metamaterials with tough and elastic properties can be created for specific applications, such as bone restoration.

Liquid Crystalline Polymers: This class of materials may be derived from esters, ester-imide, and ester-amide oligomers and are employed as high-temperature thermoset resins that employ a number of suitable photo initiators such as benzophenone, fluoroenone, and others that initiate polymeric networks via crosslinking upon exposure to UV energy.

Photocurable Silicones: Photocurable silicone resins are a class of materials that combine the benefits of both silicone rubber and photoresists offering a versatile set of properties. These resins contain organic components that can be cured using light energy, typically ultraviolet (UV) radiation and are known for their ease of processing. The resulting cured product exhibits the unique properties of silicone rubbers, such as flexibility, elasticity, and thermal stability, while also offering the advantage of being processed through photopolymerization techniques. Their wide range of applications includes adhesives, coatings, mold making, medical implants, and optoelectronic devices. Photocurable silicone resins can be classified into two main categories based on their curing mechanism: (1) Cationic curable silicone resins rely on the addition of a cationic initiator system to trigger the polymerization reaction upon exposure to UV light and generally utilize higher energy sources, such as deep UV lamps, to achieve complete cure. (2) Free radical curable silicone resins utilize free radical initiators to promote polymerization when exposed to UV light.

Free radical curable silicone resins typically cure with lower energy sources, such as visible light or LED systems, for curing. Applications of photocurable silicone resins include: (1) Adhesive and coating technologies: Due to their excellent adhesion properties, photocurable silicone resins can be used as adhesives and coatings in various industries, such as automotive, electronics, and medical devices. (2) Mold making and casting: Photocurable silicone resins can be employed as mold materials for producing complex shapes and structures, particularly in the production of microfluidic devices. (3) Medical implants: Biocompatible photocurable silicone resins can be utilized in the fabrication of medical implants, such as stents and catheters, which integrate flexible and biologically compatible materials. (4) Optoelectronic devices: Photocurable silicone resins can be incorporated into optoelectronic devices, such as solar cells and sensors, to improve their optical and electrical properties.

Multi-Phase Composites: Multi-phase composites typically consist of a core (liquid, solid) polymer material and a reinforcing material, such as chopped or continuous fiber, graphene, carbon nanotubes, ceramic material, bio-ceramic, clay, etc. These composites offer higher strength and stiffness compared to non-reinforced polymers and can replace metals such as aluminum. Some common types of composite materials used in PD3DP printing include (1) Short-Fiber Reinforced Composites including ABS composites, epoxy resin composites, nylon composites, and polylactic acid composites; (2) Particle Reinforced Composites including filled biopolymers, acrylics, polystyrene, and nylon composites.

Biological Resins and Composites: Biological resins refer to materials derived from natural sources or designed to mimic biological tissues. These resins have great potential for creating bio-compatible, biodegradable, and sustainable devices, membranes, filters, scaffolds, etc. These materials are biocompatible, biodegradable, and overall sustainable. Examples include (1) Collagen, a protein found abundantly in animal connective tissue. It has been used as a scaffolding material for tissue engineering, where it provides structural support for growing new cells. Collagen-based PD3DP prints can be used in regenerative medicine, wound healing, and dental applications. (2) Alginate, a naturally occurring polysaccharide extracted from brown seaweed. It has been used as a biocompatible and biodegradable material for temporary implants, such as wound dressings and drug delivery vehicles. PD3DP printed alginate constructs can be applied in tissue engineering, drug delivery, and controlled release systems. (3) Plant-derived polymers, such as polylactic acid (PLA), polyhydroxybutyrate (PHB), polyhydroxyaldanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO) and their copolymers, and other plant-derived polymers that are synthesized from renewable resources such as cornstarch and soybean oil, to name but a few. This class of materials are considered non-acid catalyzed polymers and are derived from sources such as corn or other carbohydrate precursors, making them environmentally friendly alternatives to traditional plastics. These biodegradable polymers could be used in various PD3DP printing applications, including medical devices, packaging, sporting, and consumer goods. (4) Decellularized extracellular matrix (ECM), bio-scaffold or acellular matrix can serve as a template for tissue repair and regeneration, especially in cases where the original tissue has been damaged or lost. (5) Bioinks are specialized ink formulations designed specifically for 3D bioprinting. They consist of living cells suspended in a supportive matrix, such as collagen or gelatin, which allows the cells to maintain their viability and functionality during the printing process. Bioink-based PD3DP prints can be used in tissue engineering, organ modeling, and personalized medicine.

Photocurable Epoxies: Photocurable epoxies that can be PD3DP printed typically consist of a combination of monomers, initiators, and other additives. These materials undergo photopolymerization allowing them to be used in various PD3DP printing techniques such as the PD3DP process. Some key components of photocurable epoxies include monomers such as 4′-pentyl-4-cyanobiphenyl to improve the dispersion and rheological properties of the resin. Initiators include benzophenone and others that play a crucial role in triggering the polymerization reaction. They absorb light energy and generate free radicals, leading to the formation of polymers. Inert fillers or additives may be incorporated into the resin to enhance specific properties, such as mechanical strength or flexibility. Applications of PD3DP printed photocurable epoxies span across various industries, including (1) Orthodontics: Photocurable compositions have been developed for the manufacture of transparent orthodontic devices; (2) Flexible Materials: Epoxy-based compositions have been created for the production of flexible material-based objects.

Photocurable Ceramic Preforms: The composition of photocurable ceramic preforms involves the use of preceramic polymers, which have editable and designable molecular structures suitable for various PD3DP printing processes. These precursors undergo a series of chemical reactions during the sintering or firing process, resulting in the formation of dense, high-quality ceramic materials. Some examples of renewable photopolymer resins include those based on biobased acrylates, which have been developed for processes similar to the PD3DP process. Applications of PD3DP printed photocurable ceramic materials span across various industries, including energy storage devices like batteries and capacitors, solar cells, and even smart glass. The unique properties of these materials make them ideal for creating complex geometries and intricate designs that would otherwise be difficult or impossible to achieve through traditional manufacturing methods.

Hydrogels: Photocurable hydrogels typically consist of crosslinked networks formed by photoinitiated polymerization of monomer solutions containing water. These hydrogels exhibit excellent swelling behavior and can be tailored to meet specific targets in terms of mechanical properties, degradation rates, and biological responses. Key components of photocurable hydrogels include (1) monomers such as methacrylic acid (MA), ethylene glycol dimethacrylate (EGDMA), and N,N′-methylenebis(acrylamide) (MBAA) that are commonly used in the synthesis of photocurable hydrogels; (2) Crosslinkers like EGDMA and MBAA help form the interconnected network structure of the hydrogel; (3) Photo initiators such as Irgacure 2959 and LAPOX are essential for initiating the polymerization process when exposed to light; (4) Water content plays a significant role in determining the final properties of the hydrogel, such as its swelling capacity and mechanical strength.

Applications of PD3DP printed hydrogel materials are diverse and span across various fields, including tissue engineering, drug delivery systems, and soft robotics. Some potential uses include (1) Biomedical implants engineered to mimic the mechanical properties and biocompatibility of natural tissues, making them suitable for use in medical implants; (2) Drug delivery hydrogel scaffolds that can be designed to release drugs at controlled rates, providing targeted therapy for specific diseases; (3) Soft robots produced from hydrogels that can be used to develop soft robotic actuators capable of adapting to different environments and performing tasks requiring delicate manipulation.

Many embodiments of the present systems, processes, etc., employ polymerizable fluids or liquids: The PD3DP process allows pressure to be delivered to any suitable UV-energy polymerizable liquid in the present idea. The liquid, or resin, may include a monomer and initiator such as a free-radical initiator. Examples include acrylics, styrene and styrene derivatives, olefins, acrylamides, alkenes, maleic anhydride, alkynes, multifunctional monomers, polyethylene glycol (PEG), Diglycyl-ether Bisphenol A epoxies or other epoxy systems, vegetable oil-based polymers, biopolymers derived from any natural resource, and composites thereof that are comprised of a liquid phase and at least one other phase material.

### EXAMPLES

### Example 1: Open Shell PD3DP Print Beverage Container Plus Plug

In this example an open shell beverage glass is 3D dynamically printed demonstrating the utility of PD3DP process, the dynamic shell is built in open air and is the finished product. The drinking glass is built immersed inside the build envelope with overflow resin which is collected in a resin storage reservoir. In our example break away supports are printed partition style at the time of printing.

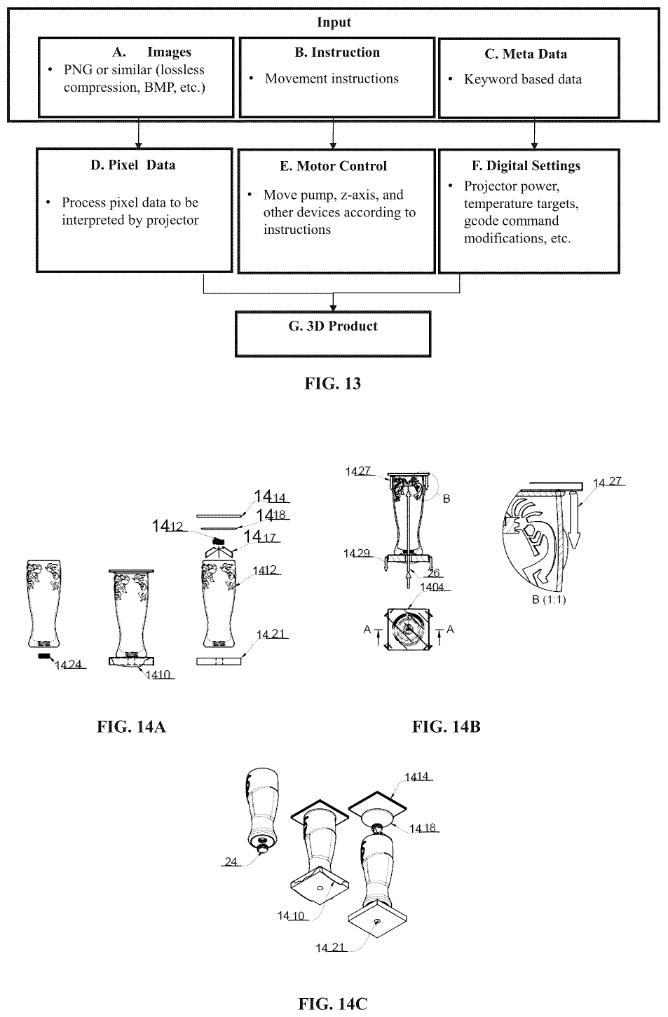

In FIG. 14, a series of drawings illustrate an exemplary open shell print process.

To begin printing the open shell 3D drinking glass (1412a) and threaded plug (1412b) the build plate inlet is covered with a layer of resin (1421), resin spilling over the build plate (1410) in the downward direction (1429).

The dynamically created resin immersion field (1418) enables the build process supplying resin spanning the top of the shell with a bead perimeter formed and limited by surface tension.

The inward flow of resin into each layer completely fills the glass as it is built (1426) by pumping over the top of the immersion field flowing down (1427) in the direction of the build plate (1429).

The transparent projection plate (1414) above the immersion field allows for UV exposure with supports formed during the print process (1417).

The open shell drink glass and plug are completed with the removable plug able to be threaded, in this case, upon print completion (1424).

### Example 2: Closed Shell PD3DP Printing of Pyramid

In this example, a 3D pyramid is printed within the closed shell that is built as the print proceeds. In this method the channels that deliver resin are built either within the structure enabling resin delivery or on the outside of the structure. The advantage is the resin delivery can be constructed as the part is built to deliver resin selectively enabling complex structures such as pyramidal structures, tubular structures, etc.

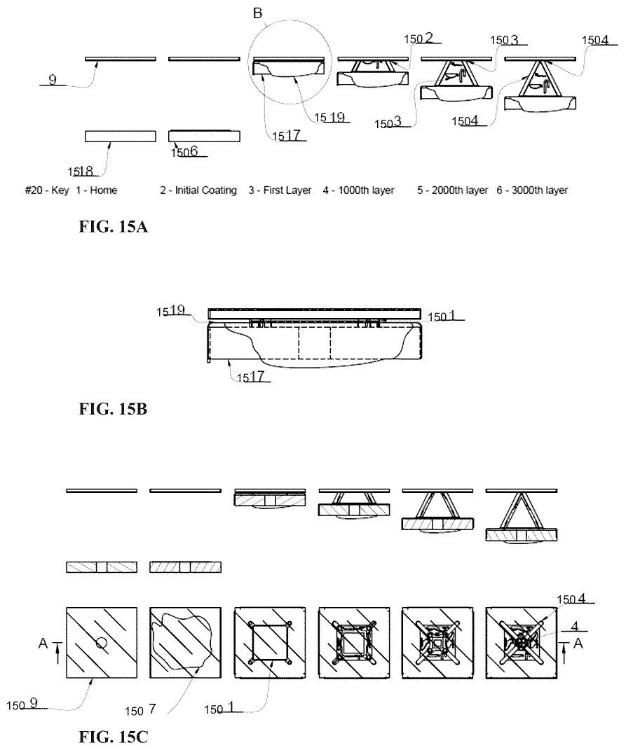

In FIG. 15 the overall closed shell PD3DP print process is depicted.

In FIG. 15(A), the build plate is shown in the home position (1518) with the transparent projection plate (1509) above. With the resin coating the build plate (1506) the build plate moves to the first layer position (1517) and resin spills over the edge (1519). Immersion fields are created as layers are build (1502, 1503, 1504) enabling the pyramid to progress through the build cycle.

FIG. 15(B) illustrates a close up of the first layer print. In this image the dynamically printed distribution manifold (1501) illustrating immersion is first coating on build plate meets the resin covering the build plate (1519) giving detail to the build plate position at the first layer (1517).

FIG. 15 (C) illustrates both a side and top view of the print process as it proceeds. In the left-hand image, through the transparent project plate one can see the hole through the plate. The hollow pyramid (1507) is dynamically printed through a series of immersion fields created in the process (1504).

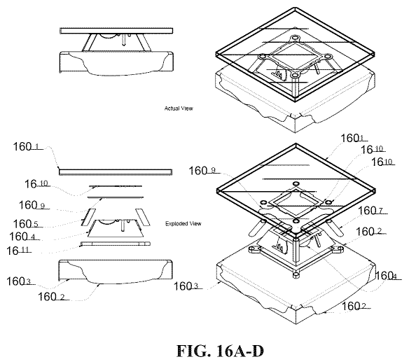

FIG. 16 is a close up of the build process as the dynamically PD3DP printed closed shell is created.

In FIG. 16 the build plate (1603) supports the dynamically printed resin distribution manifold (1602) with the figure being printed (1604) sitting on the printed manifold (1611) with the attached printed resin tubes up the side (1605,1607).

In FIG. 16, the next layer is created via the resin immersion field created to hold resin onto the projection by surface tension around the perimeter (1609); from this position the image is projected onto the plate and cured by exposing the photosensitive resin to UV light (1610).

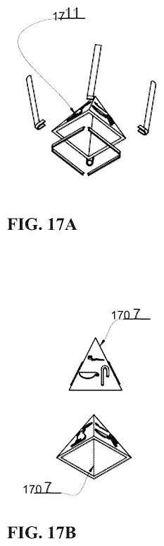

In FIG. 17, the resulting hollow pyramid or target object is depicted (1707) with the target object break off tubes and manifold illustrated in detail (1711).

### Example 3: Closed Shell PD3DP Printing Drinking Glass

In this example, a PD3DP printed beverage container is printed within the closed shell that is built during the part construction. In this method the channels deliver resin built either within the structure enabling resin to be delivered to the location where the object being built proceeds or located at the outside of the structure. This example illustrates the construction of a drinking glass that remains a thin-walled structure as resin is pumped from the center over the edges, each successive layer cured to build the part.

In FIG. 18, a drinking glass (1802) is printed from resin delivered from the main resin inlet (1833) in the vertical direction (1832) to the immersion field (1807). Once in the immersion field (1807) it immerses and is compressed by the projection plane (1806) and flows out of the immersion field (1831).

In FIG. 18, for special features, resin is delivered through the inlet port for plumping through the dynamically printed plumbing (manifold, up tubes) (1839) up the dynamically created resin tube (1838) to the immersion field (1807).

At this projection plane (1806), pressure is applied to the immersion field (1807) forcing excess resin out of the field (1831) which then travels down to the part to the build plate and flow over (1837) and off the build plate (1811).

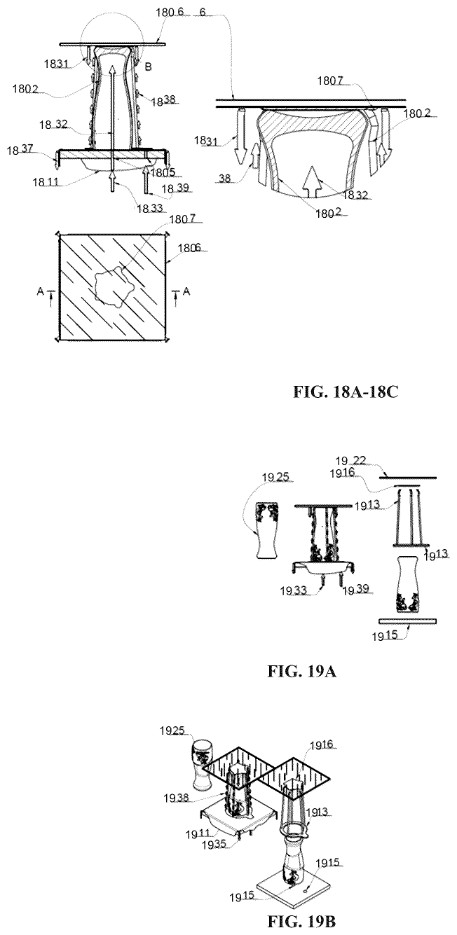

In FIG. 19 (A), the drinking glass (1925) is shown in different states of the PD3DP print process.

In FIG. 19 (A), the build plate (1915) with two inlet ports, one feeding the manifold (1933) and the other supply tubes (1913) up to the immersion field (1916).

In FIG. 19 (A), the dynamically created resin supply tube and manifold (1913) transport resin to the immersion field (1916) where the projection plate (1922) applies pressure to the layer to be exposed to UV creating a solid layer, the excess resin flows down the side of the object and spills over the build plate (1939).

In FIG. 19 (B), resin has used the dynamically created resin tube(s) (1938) to fill the immersion field (1916). The excess resin spills off the build plate (1911) and flows downwards (1935).

In FIG. 19 (19B), at the conclusion of the drinking glass build, the build plate (1915) is lowered with the finished drinking glass attached while the dynamically created resin supply tube and manifold (1913) is a separate piece from the build plate (1915) and the immersion field (1916).

### Example 4: Open Shell PD3DP Print Barb Fitting

In this example, an open shell PD3DP print of a multi-port barb fitting (2001) is 3D dynamically printed.

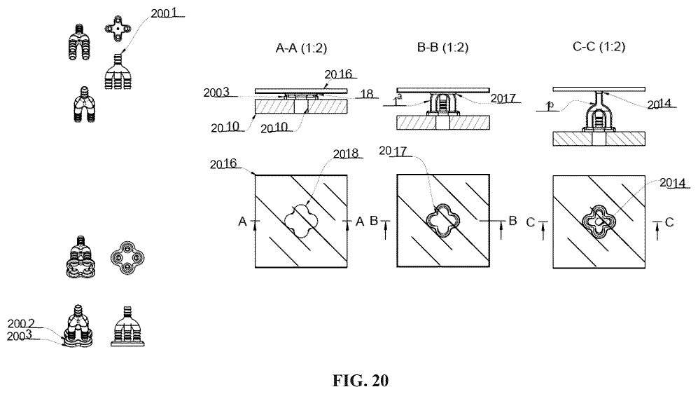

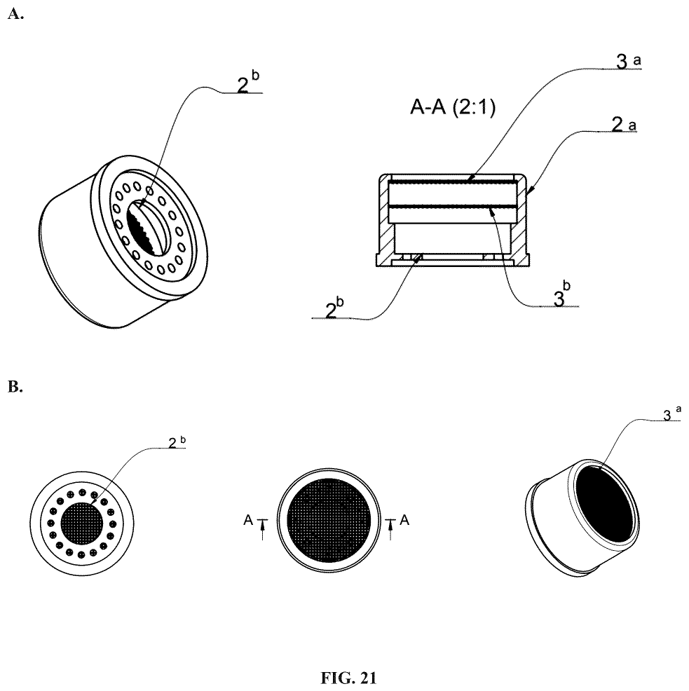

In FIG. 20, resin is pumped through the build plate (2010) to the immersion field for the manifold (2018), is subjected to applied pressure by the projection plane (2016) creating the resin field base support (2003).

In FIG. 20, the build continues by pumping resin to the immersion field for the bottom half of the barbed fitting (2017) with the projection plane (2016) applying pressure to each new layer, curing with UV.

In FIG. 20, the top half of the barbed fitting is PD3DP printed from the immersion field (2014), with the barbed fitting transitioning from four ports to a single port.

### Example 5: PD3DP Filters and Filtration Apparatus

PD3DP printing of Filters and Filtration apparatus has become an important need and market. For example, the past 10 years have seen a rapid increase in PD3DP printing of water treatment and purification membrane separators. Researchers have started evaluating 3D-printed materials for membrane separation, water treatment and purification process applications. This stems from the issue of global water resource scarcity where solutions could include new membrane technology (spacers, modules, and membrane fabrication), new approaches to oil/water separation, filters for dye capture and catalysis, etc. In water purification water permeates through the membranes where contaminants including plastic microparticles, oil droplets and solutes are rejected by the membrane.

Producing near-ideal porous structures results in properties that include increased durability, resistance to breakage, anti-bacterial and anti-biofouling properties, high flow rates with reduced cost and increased durability. Some problems inhibiting large-scale adoption include limited resolution in layer height. This is a particularly significant limitation for the direct fabrication of membranes where layer height and pore sizes of most membranes are at the micron level.

PD3DP produced membranes have consolidation leading to better mechanical performance. The material and the particular PD3DP print technique dictate the resulting properties and performance of the membranes. Mechanical strength is an important parameter and PD3DP filters and membranes should be able to withstand high amounts of pressure under various challenging environments. This is especially true with wastewater or saline water where the pH level may be extreme or there are various impurities in the solution.

3D-printed materials for membrane separation, water treatment and purification process applications have been explored. One need is global water resource scarcity where solutions could include new membrane technology (spacers, modules, and membrane fabrication), new approaches to oil/water separation, filters for dye capture and catalysis, etc. PD3DP filters and membranes can be useful for such purposes. For example, Applicant printed membranes using 1000 cp resin (0.001 Pa·s/cp), or 1 Pa·s over an area of 0.1 m² at 0.001 m each layer. To calculate the overall print rate, and the impact of pressure Applicant used the following:

$$Volume ( V ) = Area ( A ) ⋆ Depth ( h ) = 0.1 {m}^{2} ⋆ 0.001 m = 0.0001 {m}^{3}$$

Flow rate (laminar) in thin gaps is determined by the Hagen-Poiseuille equation for laminar flow in thin gaps between parallel plates:

$$Flow rate ( Q ) = Δ p ( 12 μ * h ) * {A}^{2}$$

where:
Δp=the pressure difference across the plate (1000 Pa)
μ=the viscosity of the liquid (1 Pa·s)
h=the gap thickness (0.001 m)
A=the area of the plate (0.1 m²)
   Substituting the values: Q=1000 Pa/(12*1 Pa·s*0.001 m)*(0.1 m²) 2=83.3333 m³/s

To calculate the fill time, divide the volume by the flow rate to get the time it takes to fill the gap:

$$Filling time ( t ) = Volume ( V ) / Flow rate ( Q ) = 0.0001 {m}^{3} / 8 3.3333 {m}^{3} / s = 0.000012 seconds$$

This calculated time step is due to the small area, shallow depth, and relatively high pressure. Incorporating factors such as surface roughness, non-uniform pressure and temperature has a significant impact on the fill rate—estimates are up to a factor of 1000×. This illustrates that pressure changes directly impact flow rates. This has a direct impact on the overall fill time and print speed.

This in turn has a direct impact on the overall fill time and print throughput.

FIGS. 21A-21B depict a filter made by a Pressure Delivered 3D Dynamic Printing (PD3DP) system as discussed herein. In FIGS. 21A-21B, canister 2a holds filters 3a, 3b, with fluid to be filtered passing through port 2b.

### Example 5: Mixed Mode PD3DP System

In this example, the PD3DP system conducts both pressurized PD3DP printing and surface tension PD3DP printing, referred to herein as “Mixed Mode”. Mixed Mode PD3DP printing can include integration of at least one projection panel cartridge for: (1) a pressure projection panel for pressurized PD3DP printing, and (2) a wiper for surface tension printing (the wiper can in some embodiments be disposed in a location other than the projection panel cartridge). This can be advantageous for producing target objects where wipers for surface tension-based delivery of 3D printing material is helpful, which in turn can result in ease of separation from the build plate. Examples include un-anchored guy wires and delicate 3D printed membranes and filters.

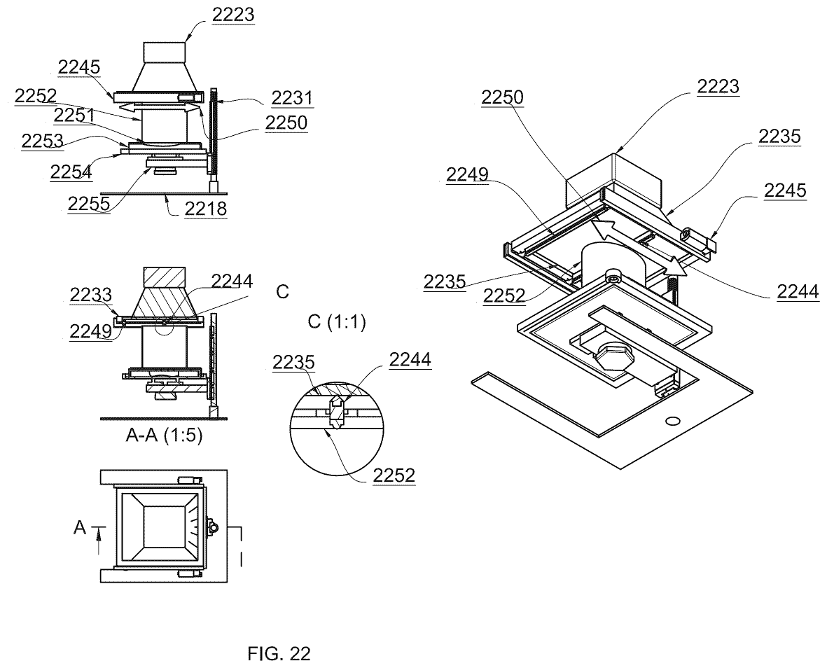

In FIG. 22, a base plate stand (2218) supports a mounting bracket (2255) attached to the stand.

In FIG. 22, the motorized wiper motor (2245) travels transverse to the z-direction (2231).

In FIG. 22, As the wiper moves over the part excess resin spills (2251) over the dynamically created shell/target object (2252) to the build plate (2253) and returns to the resin catchment (2254).

In FIG. 22, at the mid-span, the wiper moves (2244) across the dynamically created shell/target object (2252) at the closely controlled interface (2235) terminating at the projection plane frame (2233).

In FIG. 22, the layer is cured via energy delivered from the projection source (2223).

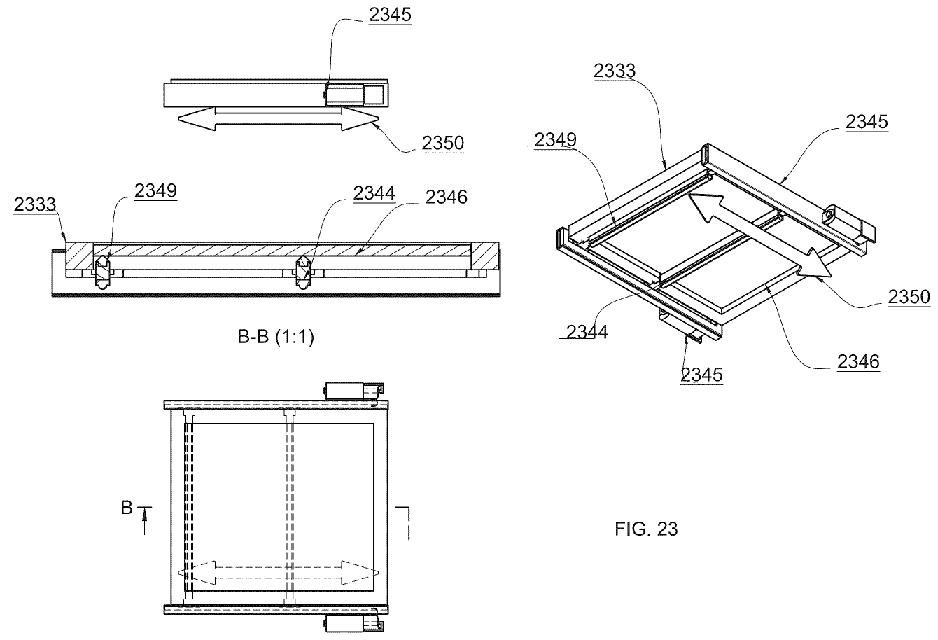

In FIG. 23, the wipers move across the shell/target (2350) and at the end of a single wipe, the wiper is in the single swipe parked location (2349).

In FIG. 23, through the transparent projection panel (2346) the projection source (2323) delivers energy to cure the layer.

All terms used herein are used in accordance with their ordinary meanings unless the context or definition clearly indicates otherwise. Also, unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

Unless otherwise stated, adjectives herein such as “substantially” and “about” that modify a condition or relationship characteristic of a feature or features of an embodiment, indicate that the condition or characteristic is defined to within tolerances that are acceptable for operation of the embodiment for an application for which it is intended.

The scope of the present devices, systems, and methods, etc., includes both means plus function and step plus function concepts. However, the claims are not to be interpreted as indicating a “means plus function” relationship unless the word “means” is specifically recited in a claim and are to be interpreted as indicating a “means plus function” relationship where the word “means” is specifically recited in a claim. Similarly, the claims are not to be interpreted as indicating a “step plus function” relationship unless the word “step” is specifically recited in a claim and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited by the figures herein. Thus, these and other aspects, features and embodiments are set forth within this application. Unless expressly stated otherwise, all embodiments, aspects, features, etc., can be mixed and matched, combined and permuted in any desired manner. In addition, any references set forth herein, including in the Cross-Reference To Related Applications, that discuss certain systems, apparatus, methods and other information; all such references are incorporated herein by reference in their entirety and for all their teachings and disclosures, regardless of where the references may appear in this application.

1. A 3D printing system, comprising:
a curing energy source;
an inlet port for a 3D-printing material;
a pressure projection panel disposed in a build arena between the curing energy source and the inlet port for the 3D-printing material; and
computer-implemented programming, stored in a memory, configured to selectively cyclically press the pressure projection panel and the 3D-printing material against each other and release from each other in the build arena in coordination with layer-by-layer printing of at least one target object in the build arena.

2. The 3D printing system of claim 1, wherein the build arena comprises a build plate at an opposing side of the build arena opposite to the pressure projection panel, the projection panel or the build plate being controllably selectively moveable away from or toward each other in a z-axis in a layer-by-layer fashion, and wherein the projection panel is configured to selectively apply at least one of positive pressure or negative pressure to the 3D-printing material as the 3D-printing material is applied to a layer of the at least one target object being printed in the build arena.

3. The 3D printing system of claim 2, wherein the projection panel selectively applies both the positive pressure and the negative pressure.

4. The 3D printing system of claim 1, wherein the computer-implemented programming causes the pressure projection panel to selectively apply pressure to create an immersion field within at least one of the target object or an encircling shell fully encircling the target object, wherein the immersion field contains liquid 3D-printing material up to at least about a top of the target object or encircling shell.

5. The 3D printing system of claim 4, wherein the computer-implemented programming causes the pressure projection panel to selectively apply pressure to create a perimeter bead of the liquid 3D-printing material at a top of the immersion field, the perimeter bead being held in place by surface tension.

6. The 3D printing system of claim 1, wherein the computer-implemented programming causes the curing energy source to selectively direct a 3D print pattern from the curing energy source to a top of the 3D-printing material.

7. The 3D printing system of claim 6, wherein the computer-implemented programming causes the curing energy source to selectively direct the 3D print pattern from the curing energy source to the top of the 3D-printing material in a step-wise fashion to successively build the target object in a layer-by-layer fashion.

8. The 3D printing system of claim 1, wherein the inlet port traverses through the build plate.

9. The 3D printing system of claim 1, wherein the pressure projection panel is transparent.

10. The 3D printing system of claim 1, wherein the pressure projection panel is pliable.

11. The 3D printing system of claim 1, wherein the pressure projection panel is low-friction.

12-20. (canceled)

21. The 3D printing system of claim 1, wherein the computer-implemented programming contains instructions for controlling pressure applied to the 3D-printing material, layer thickness, energy delivered to uncured 3D-printing material, and timing of build plate release from the pressure projection panel.

22. The 3D printing system of claim 1, further comprising a reversible pump to deliver the 3D-printing material to the build arena.

23. The 3D printing system of claim 22, wherein the computer-implemented programming controls the reversible pump to deliver the 3D-printing material at a controlled micrometer level to the build arena.

24. The 3D printing system of claim 23, wherein the computer-implemented programming controls delivery of the 3D-printing material by the reversible pump to control pressure within the 3D-printing material.

25. The 3D printing system of claim 1, further comprising a 3D-printing material catchment system to catch and redeploy unused 3D-printing material.

26. The 3D printing system of claim 1, wherein computer-implemented programming causes the pressure projection panel to press against the 3D-printing material after a new layer of the 3D-printing material has been introduced into the build arena and before directing curing energy to the new layer of the 3D-printing material.

27. The 3D printing system of claim 1, wherein the build plate is configured to move toward and away from pressure projection panel as a part of delivery of the 3D-printing material to the build arena and release of cured 3D-printing material from the pressure projection panel.

28. The 3D printing system of claim 2, wherein the positive pressure and the negative pressure are implemented by applying or reversing the direction of flow of the 3D-printing material into the build arena.

29. The 3D printing system of claim 1, wherein the system lacks a preexisting printing vat in the build arena.

30-31. (canceled)

32. The 3D printing system of claim 1, wherein the computer-implemented programming comprises instructions to print the at least one target object.

33. The 3D printing system of claim 32, wherein the computer-implemented programming comprises instructions to print the at least one target object and not to print any surrounding structure.

34. The 3D printing system of claim 33, wherein an outer surface of the at least one target object has no unintended bumps, flashing, or ridges, extending more than 0.1 mm from the outer surface.

35. The 3D printing system of claim 34, wherein an outer surface of the at least one target object has no surface artifact extending more than 0.01 mm from the outer surface.

36. The 3D printing system of claim 35, wherein the surface artifact is at least one of an unintended bump, flashing, or ridge.

37. The 3D printing system of claim 32, wherein the computer-implemented programming comprises instructions to print the at least one target object within an encircling shell fully encircling the target object.

38. The 3D printing system of claim 37, wherein the instructions to print the at least one target object include instructions to dynamically create non-vertical guywires that hold the at least one target object to the encircling shell.

39. The 3D printing system of claim 38, wherein the dynamically created, non-vertical guywires are about 200 μm or less in diameter.

40. The 3D printing system of claim 37, wherein the encircling shell and the at least one target object are made of a same 3D-printing material.

41. The 3D printing system of claim 37, wherein the encircling shell and the at least one target object each contain different 3D-printing materials.

42. The 3D printing system of claim 37, wherein the encircling shell further holds at least one dynamically created auxiliary structure.

43. The 3D printing system of claim 42, wherein the auxiliary structure comprises a plumbing that conducts 3D-printing material from a first location within the encircling shell to a second location within the encircling shell.

44. (canceled)

45. The 3D printing system of claim 1, wherein the 3D-printing material is a photosensitive liquid resin, and the 3D printing system comprises a top down stereolithography (SLA) or digital light projection (DLP) system capable of 3D printing the at least one target object from the photosensitive liquid resin.

46. The 3D printing system of claim 1, wherein the 3D-printing material is a photosensitive liquid resin, and the 3D printing system comprises a bottom up stereolithography (SLA) or digital light projection (DLP) system capable of 3D printing the at least one target object from the photosensitive liquid resin.

47. The 3D printing system of claim 37, further comprising a plurality of inlet ports supplying 3D-printing material to the encircling shell, each inlet port supplying a different 3D-printing material.

48. The 3D printing system of claim 37, further comprising a plurality of inlet ports supplying 3D-printing material to the encircling shell, each inlet port supplying a same 3D-printing material.

49. The 3D printing system of claim 47, wherein the different 3D-printing materials are different photosensitive resins.

50. (canceled)

51. The 3D printing system of claim 1, wherein the computer-implemented programming comprises instructions to pump the 3D-printing material against the pressure projection panel at a positive pressure of about 70 to 140000 Pascals.

52-76. (canceled)

77. The 3D printing system of claim 37, wherein the encircling shell includes a dynamically-created auxiliary structure comprising a plumbing configured to conduct 3D-printing material from a first location within the encircling shell to a second location within the encircling shell during the printing of the encircling shell and the at least one target object.

78-85. (canceled)
